(19) United States
(12) Patent Application Publication
(10) Pub. No.: US 2013/0057376 A1
(43) Pub. Date: Mar. 7, 2013

(54) FERRITE CERAMIC COMPOSITION, CERAMIC ELECTRONIC COMPONENT, AND PROCESS FOR PRODUCING CERAMIC ELECTRONIC COMPONENT

(71) Applicants: Atsushi YAMAMOTO, Kyoto-fu (JP); Akihiro NAKAMURA, Kyoto-fu (JP); Wataru KANAMI, Kyoto-fu (JP)

(72) Inventors: Atsushi YAMAMOTO, Kyoto-fu (JP); Akihiro NAKAMURA, Kyoto-fu (JP); Wataru KANAMI, Kyoto-fu (JP)

(73) Assignee: MURATA MANUFACTURING CO., LTD., Kyoto-fu (JP)

(21) Appl. No.: 13/601,842

(22) Filed: Aug. 31, 2012

(30) Foreign Application Priority Data
Sep. 2, 2011 (JP) 2011-192022

(51) Int. Cl. C04B 35/453; H01F 27/00; H01F 41/04; H01B 1/08

(52) U.S. Cl. 336/110; 501/1; 252/519.51; 156/89.12

(57) ABSTRACT

This disclosure provides a ceramic composition, a ceramic electronic component, and process for producing a ceramic electronic component in which a ferrite ceramic composition includes CuO at a molar content of 5 mol % or less and Fe₂O₃ and Mn₂O₃ are contained at such molar contents (represented by x and y, respectively) that, when x and y are expressed by a coordinate point (x,y), the coordinate point (x,y) is located within an area bounded by coordinate points A (25,1), B (47,1), C (47,7.5), D (45,7.5), E (45,10), F (35,10), G (35,7.5) and H (25,7.5).

### CROSS REFERENCE TO RELATED APPLICATIONS

The present application claims priority to Japanese Patent Application No. 2011-192022 filed on Sep. 2, 2011, the entire contents of this application being incorporated herein by reference in its entirety.

### TECHNICAL FIELD

The technical field relates to a ferrite ceramic composition, a ceramic electronic component, and a process for producing the ceramic electronic component, and more specifically relates to a ferrite ceramic composition which can be fired simultaneously with an electrically conductive material containing Cu as the main component, a ceramic electronic component (e.g., a common mode choke coil) which is produced using the ferrite ceramic composition, and a process for producing the ceramic electronic component.

### BACKGROUND

Heretofore, common mode choke coils have been used widely for reducing common mode noises generated between signal lines or power supply lines and GND (ground) lines in various electronic devices.

In common mode choke coils, noise components are transmitted in a common mode and signal components are transmitted in a normal mode. By utilizing this difference in transmission modes, noises are reduced by separating from signals.

For example, as illustrated in FIG. 7, JP 2958523 B1 (claim 1, paragraph [0026] etc.) proposes a laminate-type common mode choke coil which comprises a sintered laminate 105 that is produced by laminating multiple insulating material layers 101, 102 and multiple coil conductors 103a to 103d, 104a to 104d on each other to form at least two coils 106, 107. The coil conductors 103a to 103d, 104a to 104d are produced such that they are electrically connected and are magnetically coupled to each other. The at least two coils 106, 107 are arranged in the direction of the lamination of the sintered laminate 105, and a distance d between adjacent two of the coil conductors that constitute the coils 106, 107 is adjusted to a smaller value than a distance D between the adjacent coils.

In JP 2958523 B1 (claim 1, paragraph [0026] etc.), the winding directions of adjacent coils are opposite to each other. As a result, a large potential difference is not produced between adjacent two of the coil conductors 103a to 103d, 104a to 104d, and the stray capacitance between the adjacent two coils 106, 107 can be reduced. By utilizing these effects, it is contemplated to produce a laminate-type common mode choke coil which can exhibit a good noise reduction effect in a high-frequency region.

In the common mode choke coil disclosed in JP 2958523 B1 (claim 1, paragraph [0026] etc.), the coils 106 and the coil 107, which have different winding directions from each other, are arranged side-by-side with a distance D apart from each other. Therefore, this type of common mode choke coil is generally called a “parallel-wound common mode choke coil”.

JP 7-45932 Y (claim 1, lines 30-42 on column 6 etc.) proposes a common mode choke coil produced by laminating an approximately square first magnetic sheet and an approximately square second magnetic sheet alternately, wherein a substantially one turn ring-shaped electrically conductive pattern having a starting end and a terminal end is formed around the first magnetic sheet to form a first coil and a substantially one turn ring-shaped electrically conductive pattern having a starting end and a terminal end is formed around the second magnetic sheet to form a second coil.

In JP 7-45932 Y (claim 1, lines 30-42 on column 6 etc.), as illustrated in FIG. 8, when a signal that is input to a section A of the first coil L1 is output to a section B, a magnetic flux α is generated. When the signal is input from a section C of the second coil L2 and output to a section D, a magnetic flux β which has a direction opposite to the direction of the magnetic flux α is generated, because the second coil L2 was wound in phase with the first coil L1. In the first coil L1 and the second coil L2, the conductive body patterns are formed around the same core and in the same number of turns. Therefore, the magnetic flux α and the magnetic flux β generated by both of the coil L1 and the coil L2 have the same density. As a result, the magnetic flux α and the magnetic flux β neutralize each other in the magnetic body. That is, the common mode choke coil cannot act as a choke coil against noises in a normal mode, and can act as a choke coil only against noises in a common mode.

The common mode choke coil disclosed in JP 7-45932 Y (claim 1, lines 30-42 on column 6 etc.) is produced by laminating the first magnetic sheet and the second magnetic sheet alternately, wherein the first and second coils are embedded in the magnetic body. Therefore, this type of common mode choke coil is called an “alternately-wound common mode choke coil”.

### SUMMARY

The present disclosure provides a ferrite ceramic composition that can have secured insulation performance and good electric properties when fired simultaneously with an electrically conductive material containing Cu as the main component, a ceramic electronic component (e.g., a common mode choke coil) that is produced using the ferrite ceramic composition, and a process for producing the ceramic electronic component.

In one aspect of the present disclosure, a ferrite ceramic composition at least Fe, Mn, Ni and Zn, and is characterized in that a molar content of Cu contained in ferrite ceramic composition is 0 to 5 mol % in terms of CuO content and, when the molar content (x (mol %)) of Fe in the ferrite ceramic composition in terms of Fe₂O₃ content and the molar content (y (mol %)) of Mn in the ferrite ceramic composition in terms of Mn₂O₃ content are expressed by a coordinate point (x,y), the coordinate point (x,y) is located within an area bounded by coordinate points A (25,1), B (47,1), C (47,7.5), D (45,7.5), E (45,10), F (35,10), G (35,7.5) and H (25,7.5).

In a more specific embodiment of the ferrite ceramic composition, the molar content of Zn is 33 mol % or less in terms of ZnO content.

In a more specific embodiment of the ferrite ceramic composition, the molar content of Zn is 6 mol % or more in terms of ZnO content.

In another aspect of the disclosure, a ceramic electronic component includes a magnetic body part, a first coil conductor, and a second coil conductor which has substantially the same shape as that of the first coil conductor and of which the starting end and the terminal end are arranged with a predetermined distance apart from the first coil conductor. The first coil conductor and the second coil conductor are embedded in the magnetic body part, each of the first coil conductor and the second coil conductor includes an electrically conductive material containing Cu as the main component, and the magnetic body part comprises any of the above-mentioned ferrite ceramic compositions.

In a more specific embodiment of the ceramic electronic component, the first and second coil conductors and the magnetic body part are fired simultaneously.

In another more specific embodiment of the ceramic electronic component, the firing is performed in an atmosphere having an oxygen partial pressure equal to or lower than the equilibrium oxygen partial pressure for Cu—Cu₂O.

In yet another aspect of the present disclosure, a process for producing a ceramic electronic component includes a calcination step of precisely weighing an Fe compound, an Mn compound, a Cu compound, a Zn compound and an Ni compound in such a manner that the molar content of Cu becomes 0 to 5 mol % in terms of CuO content and, when the molar content (x (mol %)) of Fe in terms of Fe₂O₃ content and the molar content (y (mol %)) of Mn in terms of Mn₂O₃ content are expressed by a coordinate point (x,y), the coordinate point (x,y) is located within an area bounded by coordinate points A (25,1), B (47,1), C (47,7.5), D (45,7.5), E (45,10), F (35,10), G (35,7.5) and H (25,7.5), mixing the weighed components together, and calcining the mixture, thereby producing a calcined powder; a ceramic thin layer body production step of producing ceramic thin layer bodies from the calcined powder; a first coil pattern formation step of forming a first coil pattern containing Cu as the main component on one of the ceramic thin layer bodies; a second coil pattern formation step of forming a second coil pattern containing Cu as the main component on another one of the ceramic thin layer bodies; a laminate formation step of alternately laminating a predetermined number of the ceramic thin layer bodies each having the first coil pattern formed thereon and the predetermined number of the ceramic thin layer bodies each having the second coil pattern formed thereon, thereby forming a laminate having the first coil conductors and the second coil conductors embedded therein; and a firing step of firing the laminate in a firing atmosphere having an oxygen partial pressure equal to or lower than the equilibrium oxygen partial pressure for Cu—Cu₂O.

In a more specific embodiment of the process for producing a ceramic electronic component, a via conductor for the second coil conductor, which is electrically isolated from the first coil pattern, is formed on the surface of each of the first-coil-pattern-formed ceramic thin layer bodies, and a via conductor for the first coil conductor, which is electrically isolated from the second coil pattern, is formed on the surface of each of the second-coil-pattern-formed ceramic thin layer bodies.

### BRIEF DESCRIPTION OF THE DRAWINGS

FIG. 1 is a view illustrating the content ranges of Fe₂O₃ and Mn₂O₃ for the ferrite ceramic composition according to an exemplary embodiment.

FIG. 2 is a perspective view illustrating an exemplary embodiment of a common mode choke coil as the ceramic electronic component.

FIG. 3 is an exploded top view illustrating the main part of the common mode choke coil shown in FIG. 2.

FIG. 4 is a cross sectional view of a sample for the specific resistance measurement produced in Example 1.

FIG. 5 is a view illustrating the time course of the change in resistance value of a sample according to the present disclosure produced in Example 2 along with that of a sample produced in a comparative example which is out of the scope of the present disclosure.

FIG. 6 is a view illustrating the time course of the change in resistance decrease ratio of a sample according to the present disclosure produced in Example 2 along with that of a sample produced in a comparative example which is out of the scope of the present disclosure.

FIG. 7 is a cross sectional view illustrating a parallel-wound common mode choke coil which is disclosed in JP 2958523 B1 (claim 1, paragraph [0026] etc.).

FIG. 8 is a view illustrating the principle of operation of an alternately-wound common mode choke coil which is disclosed in JP 7-45932 Y (claim 1, lines 30-42 on column 6 etc.).

### DETAILED DESCRIPTION

The performance of a common mode choke coil can be assessed by a coupling coefficient (an index representing the degree of the magnetic coupling between magnetically coupled coils). That is, the largest value for a coupling coefficient is “1”. The higher the coupling coefficient, the smaller the impedance value in a normal mode becomes and the smaller the influence on signals becomes.

In a parallel-wound common mode choke coil as disclosed in JP 2958523 B1 (claim 1, paragraph [0026] etc.), the coupling coefficient is as low as up to about 0.2, because the coil 106 and the coil 107 are arranged apart from each other. To the contrary, in an alternately-wound common mode choke coil, a higher coupling coefficient of 0.8 or more can be achieved, because the first magnetic sheet having the first coil pattern formed thereon and the second magnetic sheet having the second coil pattern formed thereon are laminated on each other. That is, it is believed that in principle, an alternately-wound common mode choke coil can provide high-performance noise reduction compared with a parallel-wound common mode choke coil.

An Ni—Zn-based material, which has been used widely in ferrite materials, is generally fired in an air atmosphere. Therefore, for firing such a magnetic material simultaneously with a coil conductor, an Ag-based material is used as the coil conductor material. However, the inventors realized the following:

In an alternately-wound common mode choke coil as disclosed in JP 7-45932 Y (claim 1, lines 30-42 on column 6 etc.), the facing area is large between a first coil and a second coil, which is an area in which potential difference is produced. Further, an Ag-based material can be migrated readily. Therefore, an alternately-wound common mode choke coil might give rise to defects when being allowed to be left under a highly humid environment for a long period, and hardly acquires high reliability.

Therefore, for preventing the occurrence of the migration, it is believed that the use of a Cu-based material as a coil conductor is desirable.

It is known that there is not any area in which Cu and Fe₂O₃ can coexist at higher temperatures of 800° C. or higher, from the relationship between the equilibrium oxygen partial pressure for Cu—Cu₂O and the equilibrium oxygen partial pressure for Fe₂O₃—Fe₃O₄.

That is, at temperatures of 800° C. or higher, when the firing is performed while setting the oxygen partial pressure so as to provide an oxidative atmosphere in which Fe₂O₃ can keep its state, Cu is also oxidized to produce Cu₂O. On the other hand, when the firing is performed in a reductive atmosphere having such an oxygen partial pressure that the state of metal Cu can be maintained, Fe₂O₃ is reduced to form Fe₃O₄.

Thus, because there is not any area in which Cu and Fe₂O₃ can coexist, if the firing is performed in a reductive atmosphere in which the oxidation of Cu does not occur, Fe₂O₃ is reduced into Fe₂O₄ and therefore a specific resistance ρ is decreased, which might result in the deterioration in electric properties.

In view of the above drawbacks, the inventors have made intensive studies on ferrite materials having a spinel-type crystal structure represented by general formula X₂O₂—MeO (wherein X represents Fe or Mn; and Me represents Zn, Cu or Ni). As a result, it is found, when the molar content of CuO is set to 5 mol % or less and the amounts of Fe₂O₃ and Mn₂O₂ added are limited within specified ranges in the ferrite material, desired good insulation performance can be achieved even if the ferrite material is fired simultaneously with a Cu-based material, and it becomes possible to produce a ceramic electronic component having good electric properties.

As a result of the further intensive studies made by the inventors, it is found that, although it is preferred to add ZnO to the ferrite magnetic composition for the purpose of achieving more superior properties, the Curie point Tc is decreased, the operation at higher temperature cannot be ensured and reliability may be deteriorated when the content of ZnO exceeds 33 mol %.

Further, from the results of the studies made by the inventors, it is found that the content of ZnO is desirably 6 mol % or more when the magnetic permeability μ of ferrite is taken into consideration.

In this regard, the present disclosure provides a ferrite ceramic composition, ceramic electronic component and process for producing the ceramic electronic component that can address one or more of the above shortcomings. Embodiments consistent with the present disclosure will now be described in detail.

One embodiment of a ferrite ceramic composition according to the present disclosure has a spinel-type crystal structure represented by general formula X₂O₃.MeO, and contains at least Fe₂O₃ and Mn₂O₃, which are trivalent element compounds, and ZnO and NiO, which are bivalent element compounds, and optionally contains CuO, which is a bivalent element compound.

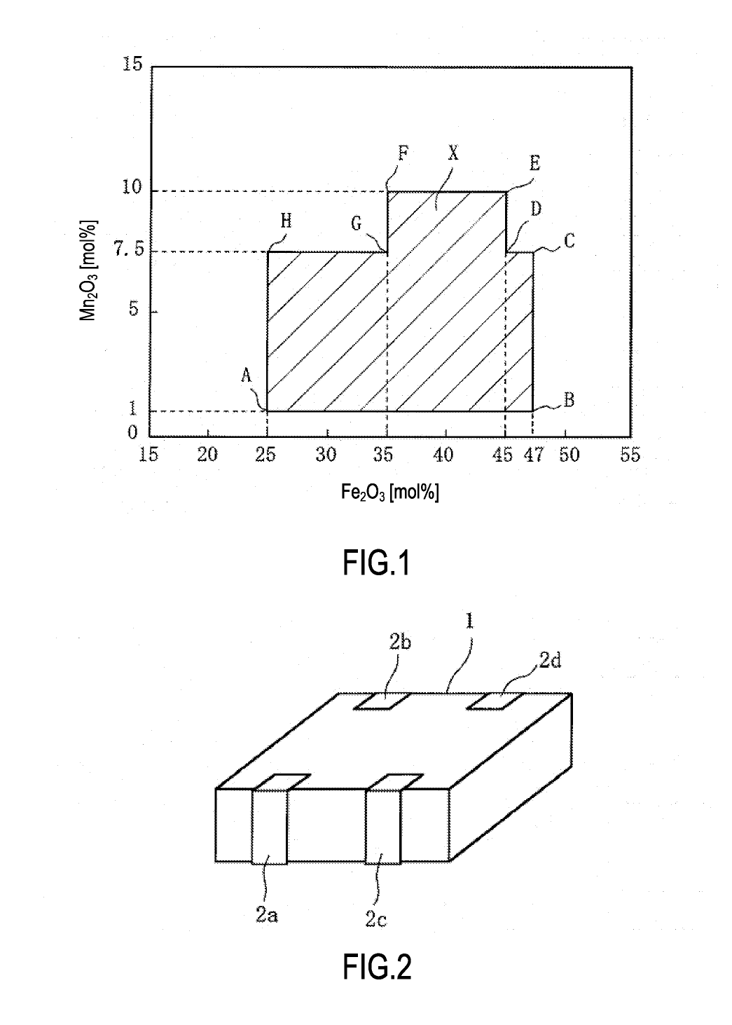

Specifically, the ferrite ceramic composition contains CuO at a molar content of 0 to 5 mol %, also contains Fe₂O₃ and Mn₂O₃ at such molar contents that, when the molar content of Fe₂O₃ is expressed by x (mol %), the molar content of Mn₂O₃ is expressed by y (mol %), and the molar content of Fe₂O₃ and the molar content of Mn₂O₂ are expressed by a coordinate point (x,y), the coordinate point (x,y) is located within a shaded area X defined by points A to H, as shown in FIG. 1, wherein the remainder of the ferrite ceramic composition is made up by ZnO and NiO.

The coordinate points A to H, each of which is expressed in the form of (x,y), correspond to the following molar contents: A (25,1), B (47,1), C (47,7.5), D (45,7.5), E (45,10), F (35,10), G (35,7.5) and H (25,7.5).

Next, the reasons why the molar contents of CuO, Fe₂O₃ and Mn₂O₂ are specified to the above-mentioned ranges will be described in detail.

(1) The Molar Content of CuO

With respect to an Ni—Zn-based ferrite, when CuO, which has a melting point of as low as 1,026° C., is added to a ferrite magnetic composition, the ferrite magnetic composition can be fired at a lower temperature and the sintering properties can be improved.

On the other hand, when a Cu-based material containing Cu as the main component and a ferrite material are fired simultaneously, if the firing is performed in an air atmosphere, Cu is oxidized readily to form Cu₂O. Therefore, it is required to perform the firing in such a reductive atmosphere that the oxidation of Cu does not occur.

However, when the firing is performed in such a reductive atmosphere, if the molar content of CuO exceeds 5 mol %, CuO in the ferrite raw material is reduced to form Cu₂O and the amount of Cu₂O in the ferrite raw material is increased, which might result in the decrease in a specific resistance ρ.

Then, in the embodiment, the amount of CuO to be added is controlled in such a manner that the molar content of CuO becomes 5 mol % or less, i.e., 0 to 5 mol %.

(2) The Molar Contents of Fe₂O₃ and Mn₂O₂

The content of Fe₂O₃ in the composition is smaller than the content defined in the stoichiometric composition, and Mn₂O₂ is contained by substituting a portion of Fe by Mn, whereby the decrease in a specific resistance ρ can be avoided and insulation performance can be improved.

That is, in the case of a spinel-type crystal structure (general formula X₂O₂.MeO), the ratio of X₂O₃ (wherein X: Fe, Mn) to MeO (wherein Me: Ni, Zn, Cu) is 50:50 according to the stoichiometric composition, and X₂O₃ and MeO are added at contents substantially defined in the stoichiometric composition.

When a Cu-based material containing Cu as the main component and the ferrite material are fired simultaneously, if the firing is performed in an air atmosphere, Cu is oxidized readily to form Cu₂O. Therefore, it is required to perform the firing in such a reductive atmosphere that the oxidation of Cu does not occur. On the other hand, if Fe₂O₃, which is the main component of the ferrite material, is fired in a reductive atmosphere, Fe₂O₄ is formed. Therefore, with respect to Fe₂O₃, it is required to perform the firing in an oxidative atmosphere.

However, as stated above, it is known that there is not any area in which both metal Cu and Fe₂O₃ can coexist when the firing is performed at a temperature of 800° C. or higher, from the relationship between the equilibrium oxygen partial pressure for Cu—Cu₂O and the equilibrium oxygen partial pressure for Fe₃O₄—Fe₂O₃.

Thus, in a temperature region of 800° C. or higher, a reductive atmosphere for Mn₂O₂ can be achieved at a higher oxygen partial pressure than that for Fe₂O₃. Therefore, at an oxygen partial pressure equal to or lower than the equilibrium oxygen partial pressure for Cu—Cu₂O, the atmosphere for Mn₂O₂ becomes strongly reductive compared that for Fe₂O₃. Therefore, the firing can be accomplished while reducing Mn₂O₂ preferentially. That is, because Mn₂O₂ is reduced preferentially than Fe₂O₃, the firing treatment can be accomplished before Fe₂O₃ is reduced into Fe₂O₄.

As stated above, when the molar content of Fe₂O₃ is smaller than that defined in the stoichiometric composition and Mn₂O₂, which is a trivalent element compound like Fe₂O₃, is added to the ferrite ceramic composition, even if a Cu-based material and the ferrite material are fired simultaneously at an oxygen partial pressure equal to or lower than the equilibrium oxygen partial pressure for Cu—Cu₂O, Mn₂O₂ is reduced preferentially and, therefore, the sintering can be accomplished before the occurrence of the reduction of Fe₂O₃. Therefore, it becomes possible to allow metal Cu and Fe₂O₃ to coexist more effectively. As a result, the decrease in a specific resistance ρ can be avoided and insulation performance can be improved.

If the molar content of Fe₂O₃ is less than 25 mol %, the molar content of Fe₂O₃ is decreased excessively. As a result, the specific resistance ρ is decreased and desired insulation performance cannot be secured any more.

If the molar content of Mn₂O₃ is less than 1 mol %, the molar content of Mn₂O₃ is reduced excessively, and therefore Fe₂O₃ can be reduced into Fe₃O₄ more readily. As a result, the specific resistance ρ is decreased and satisfactory insulation performance cannot be secured.

If the molar content of Fe₂O₃ exceeds 47 mol %, the molar content of Fe₂O₃ becomes excessive. In this case, Fe₂O₃ can also be reduced into Fe₃O₄ more readily. As a result, the specific resistance ρ is decreased and satisfactory insulation performance cannot be secured.

If the molar content of Mn₂O₃ exceeds 10 mol %, a satisfactorily high specific resistance ρ cannot be achieved and insulation performance cannot be secured.

Further, in the case where the molar content of Fe₂O₃ is 25 mol % or more but is less than 35 mol %, and in the case where the molar content of Fe₂O₃ is 45 mol % or more but less than 47 mol %, if the molar content of Mn₂O₃ exceeds 7.5 mol %, the decrease in a specific resistance ρ is caused and desired insulation performance cannot be secured.

Then, in this embodiment, the molar contents of Fe₂O₃ and Mn₂O₃ are controlled so as to fall within the area bounded by the coordinate points A to H shown in FIG. 1.

In the ferrite ceramic composition, the molar contents of ZnO and NiO are not particularly limited and can be set properly in accordance with the molar contents of Fe₂O₃, Mn₂O₃ and CuO. Preferably, ZnO and NiO are added in such a manner that the molar content of ZnO becomes 6 to 33 mol % and the remainder is made up by NiO.

If the molar content of ZnO exceeds 33 mol %, the Curie point Tc is decreased and the operation at higher temperatures may not be ensured. Therefore, the content of ZnO is preferably 33 mol % or less.

ZnO has an effect of improving a magnetic permeability μ. For achieving the effect, it is needed to add ZnO at a molar content of 6 mol %.

For the reasons stated above, the molar content of ZnO is preferably 6 to 33 mol %.

As stated above, the ferrite ceramic composition has a molar content of Cu of 0 to 5 mol % in terms of CuO content, and also has such molar contents of Fe and Mn that, when the molar content (x (mol %) of Fe in terms of Fe₂O₃ content and the molar content (y (mol %)) of Mn in terms of Mn₂O₃ content are expressed by a coordinate point (x,y), the coordinate point (x,y) is located within an area bounded by the coordinate points A to H. Therefore, when the ferrite ceramic composition is fired simultaneously with a Cu-based material, the specific resistance ρ is not decreased and desired insulation performance can be secured.

Specifically, such good insulation performance that the specific resistance ρ is 10⁷ Ω·cm or more can be achieved. Consequently, it becomes possible to produce a desired ceramic electronic component having good electric properties including an impedance property.

Further, because the molar content of ZnO is specified to 6 to 33 mol %, it becomes possible to produce a ceramic electronic component which has good magnetic permeability, in which a sufficient Curie point can be secured, and which can be operated securely under conditions including a high operation temperature.

Next, an exemplary ceramic electronic component produced using the ferrite ceramic composition will be described in detail.

FIG. 2 is a perspective view illustrating one embodiment of an alternately-wound common mode choke coil (simply referred to as a “common mode choke coil,” hereinafter) as the ceramic electronic component according to the present disclosure.

In the common mode choke coil, first to fourth external electrodes 2a to 2d are formed on both end surfaces of a component body 1.

The component body 1 includes a magnetic body part, a first coil conductor, and a second coil conductor which has substantially the same shape as that of the first coil conductor and of which the starting end and the terminal end are arranged with a predetermined distance apart from the first coil conductor. The first coil conductor and the second coil conductor are embedded in the magnetic body part. The starting end of the first coil conductor is electrically connected to the first external electrode 2a, and the terminal end of the first coil conductor is electrically connected to the second external electrode 2b. The starting end of the second coil conductor is electrically connected to the third external electrode 2c, and the terminal end of the second coil conductor is electrically connected to the fourth external electrode 2d.

In this embodiment, each of the first and second coil conductors comprises an electrically conductive material containing Cu as the main component, and the magnetic body part comprises the above-mentioned ferrite ceramic composition according to the present disclosure. By employing this constitution, it becomes possible to achieve desired good electric properties and magnetic properties and an improved specific resistance ρ of 10⁷ MΩ or more without undergoing the oxidation of Cu or the reduction of Fe₂O₃. As a result, it becomes possible to produce a common mode choke coil which exhibits high impedance in a specific frequency range and is suitable for noise absorption.

Further, because a Cu-based material is used for the coil conductors, the occurrence of migration can be avoided as much as possible even if the facing area is increased, not as in the case where an Ag-based material is used. Therefore, it becomes possible to produce a common mode choke coil having high reliability without undergoing the decrease in insulation resistance.

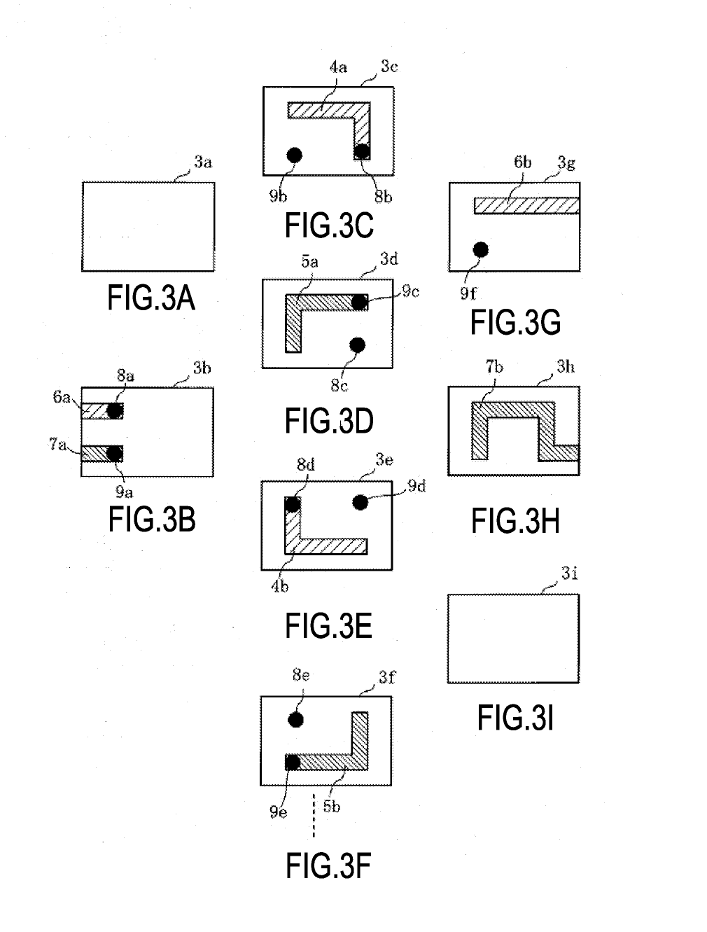

FIGS. 3A to 3I are an exploded top view of the component body 1.

An exemplary process for producing the common mode choke coil will now be described in detail with reference to FIGS. 3A to 3I.

First, Fe₂O₃, ZnO, NiO, and optionally CuO are provided as the ceramic raw materials. The ceramic raw materials are weighed precisely so as to have a CuO content of 0 to 5 mol % and such Fe₂O₃ and Mn₂O₃ contents that fulfill the specified area bounded by the coordinate points A to H.

Subsequently, the precisely weighed materials are introduced into a pot mill together with pure water and cobbled stones such as PSZ (partially stabilized zirconia) balls, the mixture is fully mixed and milled in a wet mode, and the milled product is evaporated to dryness and then calcined at a temperature of 700 to 800° C. for a predetermined time.

Subsequently, the calcined powder is introduced into the pot mill again together with an organic binder such as polyvinyl butyral, an organic solvent such as ethanol and toluene and PSZ balls, and the resultant mixture is fully mixed and milled, thereby producing a ceramic slurry.

Subsequently, the ceramic slurry is molded into a sheet-like form employing a doctor blade method or the like, thereby producing a magnetic ceramic green sheet (a ceramic thin layer body, simply referred to hereafter as “a magnetic material sheet,”) 3a to 3i having a predetermined thickness.

Subsequently, in each of the magnetic material sheets 3b to 3g, among the magnetic material sheets 3a to 3i, a via hole is formed at a predetermined position using a laser processing machine.

Subsequently, an electrically conductive paste containing Cu as the main component (referred to hereinafter as a “Cu paste”) is prepared. A first coil pattern 4a, 4b or a second coil pattern 5a, 5b is formed on each of the magnetic material sheets 3c to 3f by performing screen printing using the Cu paste, electrode patterns 6a, 6b, 7a, 7b are formed on the magnetic material sheets 3b, 3g, 3h, and the via holes are filled with the above-mentioned electrically conductive paste. In this manner, via conductors 8a to 8e, 9a to 9f are produced.

FIGS. 3C to 3F illustrate the main body part of the coil conductor. Therefore, the steps illustrated in FIGS. 3C to 3F are repeated in accordance with the number of turns required.

The magnetic material sheets 3b to 3h thus produced are laminated together, outer-covering magnetic material sheets 3a, 3i are respectively arranged on both main surfaces, the resultant product is compressed by applying a pressure, and the compressed product is cut into a predetermined size, thereby producing a laminated molding.

Thus, the electrode pattern 6a is electrically connected to the first coil pattern 4a through the via conductor 8a, the first coil pattern 4a is connected to the first coil pattern 4b through the via conductors 8b, 8c, and the first coil pattern 4b is connected to the electrode pattern 6b through the via conductors 8d, 8e. In this manner, a first coil conductor is formed.

In the same manner, the electrode pattern 7a is electrically connected to the second coil pattern 5a through the via conductors 9a, 9b, the second coil pattern 5a is connected to the second coil pattern 5b through the via conductors 9c, 9d, and the second coil pattern 5b is connected to the electrode pattern 7b through the via conductors 9e, 9f. In this manner, a second coil conductor is formed. As a result, the first coil conductor and the second coil conductor are wound alternately, and the second coil conductor is embedded in the magnetic body part in such a manner that the starting end and the terminal end of the second coil conductor are arranged with a predetermined distance apart from the first coil conductor.

Subsequently, the laminated molding is fully defatted by heating under an atmosphere in which the oxidation of Cu does not occur, is introduced into a firing furnace of which the atmosphere is adjusted with an N₂—H₂—H₂O mixed gas so as to have an oxygen partial pressure equal to or lower than the equilibrium oxygen partial pressure for Cu—Cu₂O, and is then fired at 900 to 1,050° C. for a predetermined time. In this manner, a component body 1 is produced.

Subsequently, an electrically conductive paste for external electrodes which contains Cu as the main component, is applied to side surfaces of the component body (1), and the applied electrically conductive paste is then dried and fired at 900° C., thereby forming first to fourth external electrodes 2a to 2d. In this manner, the above-mentioned common mode choke coil is produced.

As mentioned above, the embodiment includes a calcination step of precisely weighing an Fe compound, an Mn compound, a Cu compound, a Zn compound and an Ni compound in such a manner that the molar content of Cu becomes 0 to 5 mol % in terms of CuO content and, when the molar content (x (mol %)) of Fe in terms of Fe₂O₃ content and the molar content (y (mol %)) of Mn in terms of Mn₂O₃ content are expressed by a coordinate point (x,y), the coordinate point (x,y) is located within a specific area, mixing the weighed components together, and calcining the mixture, thereby producing a calcined powder. The embodiment includes a ceramic material sheet production step of producing ceramic material sheets 3a to 3i from the calcined powder, a first coil pattern formation step of forming first coil patterns by applying a Cu paste to the magnetic material sheets 3c, 3e, a second coil pattern formation step of forming second coil patterns 5a, 5b by applying the Cu paste to the magnetic material sheets 3d, 3f, a laminate formation step of alternately laminating a predetermined number of the magnetic material sheets 3c, 3e each having the first coil patterns 4a, 4b formed thereon and the predetermined number of the magnetic material sheets 3d, 3f each having the second coil patterns 5a, 5b formed thereon, thereby forming a laminate having the first coil conductor and the second coil conductor embedded therein. The embodiment includes a firing step of firing the laminate in a firing atmosphere having an oxygen partial pressure equal to or lower than the equilibrium oxygen partial pressure for Cu—Cu₂O. Therefore, when the magnetic material sheets 3a to 3 and the first and second coil conductors each containing Cu as the main component are fired simultaneously in a firing atmosphere having an oxygen partial pressure equal to or lower than the equilibrium oxygen partial pressure for Cu—Cu₂O, it becomes possible to produce a common mode choke coil having good insulation performance and high reliability without undergoing the reduction of Fe.

The present disclosure is not limited to the above-mentioned embodiments. For example, in the embodiment, the ceramic green sheets 3a to 3i are formed from the calcined powder. However, any other ceramic thin layer body may be used. For example, a magnetic coating film may be formed on a PET film by a printing treatment, and a coil pattern or a capacitance pattern, which is an electrically conductive film, may be formed on the magnetic coating film.

In the embodiment, the first and second coil patterns 4a, 4b, 5a, and 5b are formed by screen printing. However, this forming process is exemplary and a method according to the disclosure for producing the coil patterns is not also particularly limited. That is, other thin film formation methods such as a plating method, a transcription method, and a sputtering method may be employed for the formation of the coil patterns.

In the embodiment, the production of an alternately-wound common mode choke coil is described. However, this process can, of course, be employed for use in applications in which a ceramic electronic component is fired simultaneously with an electrically conductive material containing Cu as the main component, and is applicable to other ceramic electronic components, such as a trifilar-wound ceramic electronic component having three or more terminals.

Next, examples of the present disclosure are described specifically.

### Example 1

Fe₂O₃, Mn₂O₃, ZnO, CuO and NiO were provided as ceramic raw materials, and the ceramic raw materials were weighed precisely so that the molar contents of the ceramic raw materials became those shown in Tables 1 to 3. That is, the ceramic raw materials were weighed precisely in such a manner that the contents of ZnO and CuO were fixed to 30 mol % and 1 mol %, respectively, the molar content of each of Fe₂O₃ and Mn₂O₃ was varied and the remainder was made up by NiO.

Next, the precisely weighed materials were placed in a pot mill made of vinyl chloride together with pure water and PSZ balls, the mixture was fully mixed and milled in a wet mode, the resultant mixture was evaporated to dryness, and the dried product was calcined at 750° C., thereby producing a calcined powder.

Subsequently, the calcined powder was placed again in the pot mill made of vinyl chloride together with a polyvinyl butyral binder (an organic binder), ethanol (an organic solvent) and PSZ balls, and the mixture was fully mixed and milled, thereby producing a ceramic slurry.

Subsequently, the ceramic slurry was shaped into a sheet-like form having a thickness of 25 μm employing a doctor blade method, and the sheet-like material was then punched out into a size of 50 mm in length and 50 mm in width. In this manner, a magnetic material sheet was produced.

Subsequently, multiple pieces of the magnetic material sheets thus produced were laminated in such a manner that the total thickness became 1.0 mm, the resultant laminate was heated to 60° C., then compressed for 60 seconds at a pressure of 100 MPa, and then punched out into a ring shape having an outer diameter of 20 mm and an inner diameter of 12 mm. In this manner, a ceramic molding was produced.

Subsequently, the resultant ceramic molding was fully defatted by heating. An N₂—H₂—H₂O mixed gas was fed to a firing furnace to adjust the oxygen partial pressure in the firing furnace to 6.7×10⁻² Pa, and then the ceramic molding was introduced into the firing furnace and fired at 1,000° C. for 2 hours. In this manner, a ring-shaped sample was produced.

The oxygen partial pressure of 6.7×10⁻² Pa is the equilibrium oxygen partial pressure for Cu—Cu₂O at 1,000° C. The ceramic molding was fired at the equilibrium oxygen partial pressure for Cu—Cu₂O for 2 hours. In this manner, ring-shaped samples Nos. 1 to 104 were produced.

A soft copper wire was wound around each of the ring-shaped samples Nos. 1 to 104 20 turns, the inductance of the resultant product was measured at a measurement frequency of 1 MHz using an impedance analyzer (Agilent Technologies, E4991A), and a magnetic permeability μ was determined from the measurement value.

Subsequently, an organic vehicle comprising terpineol (an organic solvent) and an ethyl cellulose resin (a binder resin) was mixed with a Cu powder, and the mixture was kneaded with a triple roll mill. In this manner, a Cu paste was produced.

Subsequently, the Cu paste was screen-printed on the surface of the magnetic material sheet, thereby producing an electrically conductive film having a predetermined pattern on the magnetic material sheet. A predetermined number of the magnetic material sheets each having the electrically conductive film formed thereon were laminated in a predetermined order. The resultant laminate was intercalated between the magnetic material sheets on each of which the electrically conductive film was not formed, and the resultant laminate was compressed and then cut into a predetermined size. In this manner, a laminated molding was produced.

Subsequently, the laminated molding was fully defatted, then the oxygen partial pressure in a firing furnace was adjusted to 6.7×10⁻² Pa (the equilibrium oxygen partial pressure for Cu—Cu₂O at 1,000° C.) by supplying an N₂—H₂—H₂O mixed gas into the firing furnace, and the defatted laminated molding was introduced into the firing furnace and then fired at 1,000° C. for 2 hours. In this manner, a sintered ceramic body having the internal electrodes embedded therein was produced.

Subsequently, the sintered ceramic body was introduced into a pot together with water, and the sintered ceramic body was subjected to a barrel treatment using a centrifugal barrel machine. In this manner, a ceramic body was produced.

A paste for external electrode which contained Cu or the like as the main component was applied to both ends of the ceramic body and then dried. The resultant product was subjected to a baking treatment at 900° C. in a firing furnace of which the oxygen partial pressure was adjusted to 4.3×10⁻³ Pa. In this manner, samples for the specific resistance measurement Nos. 1 to 104 were produced. The oxygen partial pressure of 4.3×10⁻³ Pa is the equilibrium oxygen partial pressure for Cu—Cu₂O at 900° C.

Each of the specific resistance measurement samples had an outer size of 3.0 mm in length, 3.0 mm in width and 1.0 mm in thickness.

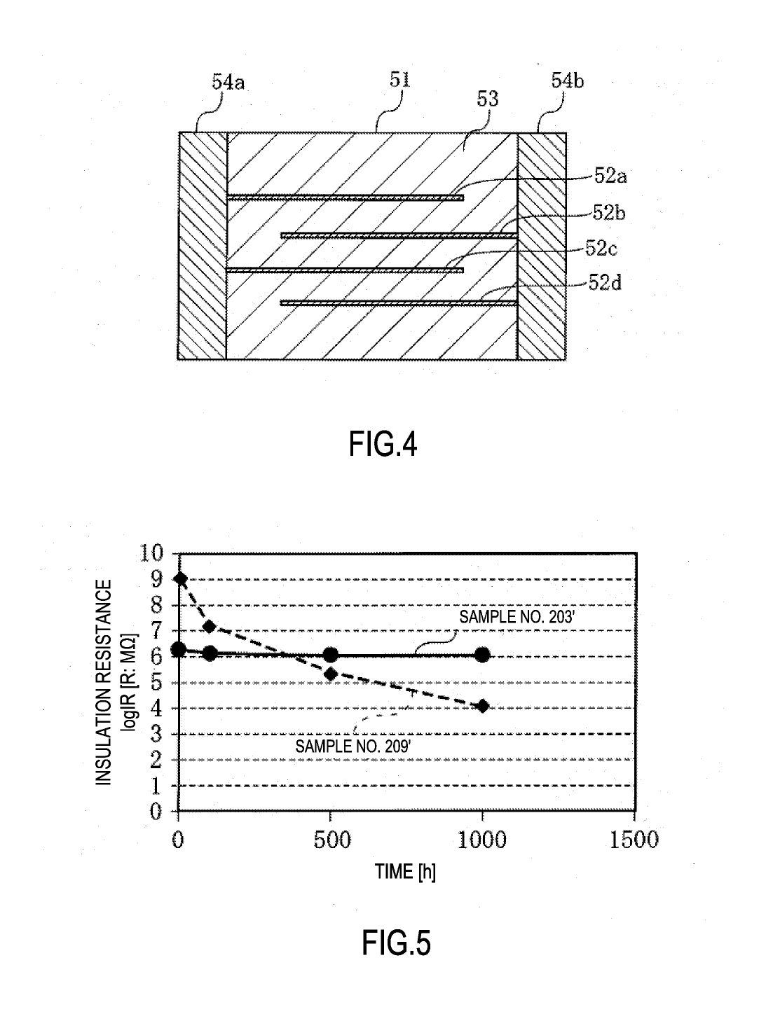

FIG. 4 is a cross sectional view of each of the specific resistance measurement samples. In the ceramic body 51, internal electrodes 52a to 52d were embedded in the magnetic material layer 53 in such a manner that the extraction sections were arranged in a staggered configuration, and external electrodes 54a, 54b were formed at both end surfaces of the ceramic body 51.

Subsequently, with respect to the specific resistance measurement samples Nos. 1 to 104, a voltage of 50 V was applied to each of the external electrodes 54a, 54b for 30 seconds, and a current generated upon the application of the voltage was measured. A resistivity was calculated from the measurement value, and a logarithm log ρ for a specific resistance (referred to hereinafter as “a specific resistance log ρ”) was calculated from the outer size of each of the samples.

In Tables 1 to 3, the ferrite compositions and the measurement results for samples Nos. 1 to 104 are shown.

TABLE 1

| | | | | | | Electric properties | |
|---|---|---|---|---|---|---|---|
| | | | | | | Specific | |
| | | | | | | resistance | Magnetic |
| Sample | Ferrite composition (mol %) | | | | | logρ, | permeability |
| No. | Fe₂O₃ | Mn₂O₃ | ZnO | CuO | NiO | ρ: Ω · cm | μ (−) |
| 1* | 49 | 0 | 30 | 1 | 20 | 2.8 | 350 |
| 2* | 49 | 1 | 30 | 1 | 19 | 3.3 | 400 |
| 3* | 49 | 2 | 30 | 1 | 18 | 3.4 | 600 |
| 4* | 49 | 5 | 30 | 1 | 15 | 3.4 | 750 |
| 5* | 49 | 7.5 | 30 | 1 | 12.5 | 3.4 | 900 |
| 6* | 49 | 10 | 30 | 1 | 10 | 3.4 | 1100 |
| 7* | 49 | 13 | 30 | 1 | 7 | 3.3 | 1250 |
| 8* | 49 | 15 | 30 | 1 | 5 | 3.1 | 1450 |
| 9* | 48 | 0 | 30 | 1 | 21 | 4.4 | 290 |
| 10* | 48 | 1 | 30 | 1 | 20 | 5.9 | 330 |
| 11* | 48 | 2 | 30 | 1 | 19 | 6.3 | 500 |
| 12* | 48 | 5 | 30 | 1 | 16 | 6.1 | 640 |
| 13* | 48 | 7.5 | 30 | 1 | 13.5 | 5.9 | 760 |
| 14* | 48 | 10 | 30 | 1 | 11 | 5.6 | 900 |
| 15* | 48 | 13 | 30 | 1 | 8 | 5 | 1050 |
| 16* | 48 | 15 | 30 | 1 | 6 | 4.3 | 1250 |
| 17* | 47 | 0 | 30 | 1 | 22 | 5.3 | 235 |
| 18 | 47 | 1 | 30 | 1 | 21 | 7 | 260 |
| 19 | 47 | 2 | 30 | 1 | 20 | 7.5 | 400 |
| 20 | 47 | 5 | 30 | 1 | 17 | 7.3 | 520 |
| 21 | 47 | 7.5 | 30 | 1 | 14.5 | 7 | 625 |
| 22* | 47 | 10 | 30 | 1 | 12 | 6.4 | 750 |
| 23* | 47 | 13 | 30 | 1 | 9 | 5.6 | 880 |
| 24* | 47 | 15 | 30 | 1 | 7 | 4.9 | 1050 |
| 25* | 46 | 0 | 30 | 1 | 23 | 5.9 | 195 |
| 26 | 46 | 1 | 30 | 1 | 22 | 7.4 | 215 |
| 27 | 46 | 2 | 30 | 1 | 21 | 7.6 | 320 |
| 28 | 46 | 5 | 30 | 1 | 18 | 7.5 | 430 |
| 29 | 46 | 7.5 | 30 | 1 | 15.5 | 7.3 | 520 |
| 30* | 46 | 10 | 30 | 1 | 13 | 6.8 | 630 |
| 31* | 46 | 13 | 30 | 1 | 10 | 6 | 730 |
| 32* | 46 | 15 | 30 | 1 | 8 | 5.2 | 880 |
| 33* | 45 | 0 | 30 | 1 | 24 | 6.2 | 165 |
| 34 | 45 | 1 | 30 | 1 | 23 | 7.7 | 180 |
| 35 | 45 | 2 | 30 | 1 | 22 | 7.9 | 250 |
| 36 | 45 | 5 | 30 | 1 | 19 | 7.8 | 340 |
| 37 | 45 | 7.5 | 30 | 1 | 16.5 | 7.6 | 420 |
| 38 | 45 | 10 | 30 | 1 | 14 | 7.1 | 520 |
| 39* | 45 | 13 | 30 | 1 | 11 | 6.3 | 600 |
| 40* | 45 | 15 | 30 | 1 | 9 | 5.4 | 720 |

*out of the scope of the disclosure (claim 1)

TABLE 2

| | | | | | | Electric properties | |
|---|---|---|---|---|---|---|---|
| | | | | | | Specific | |
| | | | | | | resistance | Magnetic |
| Sample | Ferrite composition (mol %) | | | | | logρ, | permeability |
| No. | Fe₂O₃ | Mn₂O₃ | ZnO | CuO | NiO | ρ: Ω · cm | μ (−) |
| 41* | 44 | 0 | 30 | 1 | 25 | 6.4 | 145 |
| 42 | 44 | 1 | 30 | 1 | 24 | 7.9 | 155 |
| 43 | 44 | 2 | 30 | 1 | 23 | 8 | 210 |
| 44 | 44 | 5 | 30 | 1 | 20 | 8 | 280 |
| 45 | 44 | 7.5 | 30 | 1 | 17.5 | 7.8 | 340 |
| 46 | 44 | 10 | 30 | 1 | 15 | 7.3 | 420 |
| 47* | 44 | 13 | 30 | 1 | 12 | 6.5 | 490 |
| 48* | 44 | 15 | 30 | 1 | 10 | 5.7 | 590 |
| 49* | 42 | 0 | 30 | 1 | 27 | 6.6 | 115 |
| 50 | 42 | 1 | 30 | 1 | 26 | 7.9 | 125 |
| 51 | 42 | 2 | 30 | 1 | 25 | 8.2 | 160 |
| 52 | 42 | 5 | 30 | 1 | 22 | 8.2 | 205 |
| 53 | 42 | 7.5 | 30 | 1 | 19.5 | 7.9 | 235 |
| 54 | 42 | 10 | 30 | 1 | 17 | 7.5 | 280 |
| 55* | 42 | 13 | 30 | 1 | 14 | 6.7 | 340 |
| 56* | 42 | 15 | 30 | 1 | 12 | 5.9 | 420 |
| 57* | 40 | 0 | 30 | 1 | 29 | 6.5 | 100 |
| 58 | 40 | 1 | 30 | 1 | 28 | 7.9 | 108 |
| 59 | 40 | 2 | 30 | 1 | 27 | 8 | 130 |
| 60 | 40 | 5 | 30 | 1 | 24 | 8 | 160 |
| 61 | 40 | 7.5 | 30 | 1 | 21.5 | 7.8 | 185 |
| 62 | 40 | 10 | 30 | 1 | 19 | 7.3 | 215 |
| 63* | 40 | 13 | 30 | 1 | 16 | 6.5 | 260 |
| 64* | 40 | 15 | 30 | 1 | 14 | 5.8 | 320 |
| 65* | 35 | 0 | 30 | 1 | 34 | 6.1 | 80 |
| 66 | 35 | 1 | 30 | 1 | 33 | 7.7 | 85 |
| 67 | 35 | 2 | 30 | 1 | 32 | 8 | 94 |
| 68 | 35 | 5 | 30 | 1 | 29 | 8 | 110 |
| 69 | 35 | 7.5 | 30 | 1 | 26.5 | 7.5 | 125 |
| 70 | 35 | 10 | 30 | 1 | 24 | 7 | 150 |
| 71* | 35 | 13 | 30 | 1 | 21 | 6.2 | 180 |
| 72* | 35 | 15 | 30 | 1 | 19 | 5.7 | 235 |
| 73* | 30 | 0 | 30 | 1 | 39 | 5.7 | 65 |
| 74 | 30 | 1 | 30 | 1 | 38 | 7.3 | 69 |
| 75 | 30 | 2 | 30 | 1 | 37 | 7.7 | 75 |
| 76 | 30 | 5 | 30 | 1 | 34 | 7.4 | 85 |
| 77 | 30 | 7.5 | 30 | 1 | 31.5 | 7.1 | 95 |
| 78* | 30 | 10 | 30 | 1 | 29 | 6.7 | 110 |
| 79* | 30 | 13 | 30 | 1 | 26 | 6 | 130 |
| 80* | 30 | 15 | 30 | 1 | 24 | 5.3 | 175 |

*out of the scope of the disclosure (claim 1)

TABLE 3

| | | | | | | Electric properties | |
|---|---|---|---|---|---|---|---|
| | | | | | | Specific | |
| | | | | | | resistance | Magnetic |
| Sample | Ferrite composition (mol %) | | | | | logρ, | permeability |
| No. | Fe₂O₃ | Mn₂O₃ | ZnO | CuO | NiO | ρ: Ω · cm | μ (−) |
| 81* | 25 | 0 | 30 | 1 | 44 | 5.2 | 51 |
| 82 | 25 | 1 | 30 | 1 | 43 | 7 | 54 |
| 83 | 25 | 2 | 30 | 1 | 42 | 7.3 | 59 |
| 84 | 25 | 5 | 30 | 1 | 39 | 7.1 | 67 |
| 85 | 25 | 7.5 | 30 | 1 | 36.5 | 7 | 73 |
| 86* | 25 | 10 | 30 | 1 | 34 | 6.4 | 88 |
| 87* | 25 | 13 | 30 | 1 | 31 | 5.6 | 105 |
| 88* | 25 | 15 | 30 | 1 | 29 | 4.9 | 140 |
| 89* | 20 | 0 | 30 | 1 | 49 | 4.6 | 35 |
| 90* | 20 | 1 | 30 | 1 | 48 | 6.2 | 38 |
| 91* | 20 | 2 | 30 | 1 | 47 | 6.7 | 42 |
| 92* | 20 | 5 | 30 | 1 | 44 | 6.3 | 50 |
| 93* | 20 | 7.5 | 30 | 1 | 41.5 | 5.9 | 55 |
| 94* | 20 | 10 | 30 | 1 | 39 | 5.6 | 70 |
| 95* | 20 | 13 | 30 | 1 | 36 | 5 | 87 |
| 96* | 20 | 15 | 30 | 1 | 34 | 4.4 | 120 |
| 97* | 15 | 0 | 30 | 1 | 54 | 3.9 | 18 |
| 98* | 15 | 1 | 30 | 1 | 53 | 5.4 | 20 |
| 99* | 15 | 2 | 30 | 1 | 52 | 5.8 | 25 |
| 100* | 15 | 5 | 30 | 1 | 49 | 5.4 | 33 |
| 101* | 15 | 7.5 | 30 | 1 | 46.5 | 5 | 40 |
| 102* | 15 | 10 | 30 | 1 | 44 | 4.5 | 55 |
| 103* | 15 | 13 | 30 | 1 | 41 | 3.8 | 70 |
| 104* | 15 | 15 | 30 | 1 | 39 | 3.2 | 100 |

*out of the scope of the disclosure (claim 1)

With respect to each of samples Nos. 1 to 17, 22 to 25, 30 to 33, 39 to 41, 47 to 49, 55 to 57, 63 to 65, 71 to 73, 78 to 81 and 86 to 104, the specific resistance log ρ was as small as less than 7 and desired insulation performance could not be achieved, because the composition was located in the outside of the shaded area X in FIG. 1.

To the contrary, with respect to each of samples Nos. 18 to 21, 26 to 29, 34 to 38, 42 to 46, 50 to 54, 58 to 62, 66 to 70, 74 to 77 and 82 to 85, it was found that the specific resistance log ρ was 7 or more, good insulation performance could be achieved, and a practically satisfactory level of magnetic permeability p, i.e., 50 or more, could be achieved, because the composition was located within the shaded area X in FIG. 1.

### Example 2

Ceramic raw materials were weighed precisely in such a manner that the molar content of Fe₂O₃ was 44 mol % and the molar content of Mn₂O₃ was 5 mol % (which fall within the ranges defined in the present disclosure), the molar content of ZnO was 30 mol %, the molar content of CuO was varied, and the remainder was made up by NiO, as shown in Table 4. Except this matter, the same methods and procedures as in Example 1 were performed, thereby producing ring-shaped samples Nos. 201 to 209 and specific resistance measurement samples Nos. 201 to 209 were produced.

Subsequently, with respect to each of samples Nos. 201 to 209, specific resistance log ρ and magnetic permeability were determined by the same method and procedures as in Example 1.

In Table 4, the ferrite compositions and the measurement results for Sample Nos. 201 to 209 are shown.

TABLE 4

| | | | | | | Electric properties | |
|---|---|---|---|---|---|---|---|
| | | | | | | Specific | |
| | | | | | | resistance | Magnetic |
| Sample | Ferrite composition (mol %) | | | | | logρ, | permeability |
| No. | Fe₂O₃ | Mn₂O₃ | ZnO | CuO | NiO | ρ: Ω · cm | μ (−) |
| 201 | 44 | 5 | 30 | 0 | 21 | 7.8 | 210 |
| 202 | 44 | 5 | 30 | 1 | 20 | 8 | 280 |
| 203 | 44 | 5 | 30 | 2 | 19 | 8.2 | 310 |
| 204 | 44 | 5 | 30 | 3 | 18 | 7.9 | 325 |
| 205 | 44 | 5 | 30 | 4 | 17 | 7.5 | 310 |
| 206 | 44 | 5 | 30 | 5 | 16 | 7.1 | 315 |
| 207* | 44 | 5 | 30 | 6 | 15 | 6.1 | 320 |
| 208* | 44 | 5 | 30 | 7 | 14 | 4.9 | 300 |
| 209* | 44 | 5 | 30 | 8 | 13 | 4.1 | 305 |

*out of the scope of the disclosure (claim 1)

With respect to each of samples Nos. 207 to 209, the specific resistance log ρ was as small as less than 7 and desired insulation performance could not be achieved, because the molar content of CuO exceeded 5 mol %.

To the contrary, with respect to each of samples Nos. 201 to 206, such good results were obtained that the specific resistance log ρ was 7 or more, good insulation performance could be achieved, and the magnetic permeability μ was 210 or more, because the molar content of CuO was 0 to 5 mol %, which falls within the range defined in the present disclosure.

### Example 3

Ceramic raw materials were weighed precisely in such a manner that the molar content of Fe₂O₃ became 44 mol %, the molar content of Mn₂O₃ became 5 mol % and the molar content of CuO became 1 mol %, which fall within the ranges specified in the present disclosure, the molar content of ZnO was varied, and the remainder was made up by Ni, as shown in Table 5. Except this matter, the same methods and procedures as in Example 1 were performed, thereby producing ring-shaped samples Nos. 301 to 309 and specific resistance measurement samples Nos. 301 to 309 were produced.

Subsequently, with respect to each of samples Nos. 301 to 309, specific resistance log ρ and magnetic permeability were determined by the same method and procedures as in Example 1.

With respect to each of samples Nos. 301 to 309, the temperature dependency of saturation magnetization was determined by applying a magnetic field of 1 T (tesla) using a vibrating sample magnetometer (Toei Industry Co., Ltd.; model VSM-5-15). A Curie point Tc was determined from the result of the temperature dependency of saturation magnetization.

In Table 5, the ferrite compositions and the measurement results for Sample Nos. 301 to 309 are shown.

TABLE 5

| | | | | | | Electric properties | | |
|---|---|---|---|---|---|---|---|---|
| | | | | | | Specific | | |
| | Ferrite composition | | | | | resistance | Magnetic | |
| Sample | (mol %) | | | | | logρ, | permeability | Curie point |
| No. | Fe₂O₃ | Mn₂O₃ | ZnO | CuO | NiO | ρ: Ω · cm | μ (−) | Tc (° C.) |
| 301*** | 44 | 5 | 1 | 1 | 49 | 7.1 | 15 | 550 |
| 302*** | 44 | 5 | 3 | 1 | 47 | 7.3 | 20 | 515 |
| 303 | 44 | 5 | 6 | 1 | 44 | 7.4 | 35 | 465 |
| 304 | 44 | 5 | 10 | 1 | 40 | 7.6 | 55 | 420 |
| 305 | 44 | 5 | 15 | 1 | 35 | 7.6 | 110 | 340 |
| 306 | 44 | 5 | 25 | 1 | 25 | 7.7 | 230 | 275 |
| 307 | 44 | 5 | 30 | 1 | 20 | 8 | 300 | 165 |
| 308 | 44 | 5 | 33 | 1 | 17 | 8.1 | 355 | 130 |
| 309** | 44 | 5 | 35 | 1 | 15 | 8 | 400 | 110 |

**out of the scope of the disclosure (claim 2)
***out of the scope of the disclosure (claim 3)

With respect to sample No. 309, it was found that the Curie point Tc was 110° C. which was lower than those of other samples because the molar content of ZnO exceeded 33 mol %, although the specific resistance log ρ and the magnetic permeability μ were satisfactory.

With respect to each of samples Nos. 301 and 302, the magnetic permeability μ was decreased to 20 or less because the molar content of ZnO was less than 6 mol %, although the specific resistance log ρ and the Curie point Tc were satisfactory.

To the contrary, with respect to each of samples Nos. 303 to 308, it was found that the Curie point Tc was 165° C. or higher and therefore the operation under high temperatures around 130° C. was ensured, and the magnetic permeability μ was 35 or more which was practically applicable, because the molar content of ZnO was 6 to 33 mol %.

From the above-mentioned results, it was confirmed that the magnetic permeability μ was increased when the molar content of ZnO was increased and the Curie point Tc was decreased when the molar content of ZnO was increased to be in excess.

### Example 4

A common mode choke coil was produced using a magnetic material sheet having the same composition as of sample No. 1 produced in Example 1 and magnetic material sheets respectively having the same compositions as of sample Nos. 203 and 209 produced in Example 2 (see, FIGS. 2 and 3A to 3I).

With respect to the magnetic material sheets of sample Nos. 1 and a sample No. 203, Cu was used as the first and second coil conductor materials to produce samples (common mode choke coils) Nos. 1′ and 203′.

With respect to the magnetic material sheet of a sample No. 209, Ag was used as the first and second coil conductor materials to produce a sample (a common mode choke coil) No. 209′.

For the production of a sample No. 209′, the Cu paste which was used in Examples 1 to 3 and an electrically conductive paste containing Ag as the main component (referred to hereinafter as an “Ag paste”) were prepared.

Samples No. 1′, 203′ and 209′ were produced in the following manner.

That is, a via hole was formed at a predetermined position on each of the magnetic material sheets of samples Nos. 1, 203 and 209 using a laser processing machine.

Subsequently, screen printing was performed using the Cu paste or the Ag paste to form the first and second coil patterns on the magnetic material sheet, and the via hole was filled with the Cu paste or the Ag paste. In this manner, a via conductor was produced.

The magnetic material sheets were laminated together, and outer-covering magnetic material sheets were respectively arranged on both main surfaces of the laminate. The resultant laminate was heated to 60° C., compressed by applying a pressure of 100 MPa for 60 seconds, and was then cut into a predetermined size. In this manner, laminated molding samples Nos. 1′, 203′ and 209′ were produced.

With respect to each of samples Nos. 1′ and 203′, the laminated molding was fully defatted by heating under an atmosphere in which the oxidation of Cu did not occur, was then introduced into a firing furnace of which the atmosphere was adjusted with an N₂—H₂—H₂O mixed gas so to have an oxygen partial pressure of 6.7×10⁻² Pa, and was then fired at 1,000° C. for 2 hours, thereby producing a component body.

Subsequently, an electrically conductive paste for external electrodes which contained Cu as the main component was applied to side surfaces of the component body, was then dried, and was then baked in a firing furnace in which the oxygen partial pressure was adjusted to 4.3×10⁻³ Pa at 900° C. In this manner, first to fourth external electrodes were produced. Each of the first to fourth external electrodes was subjected to electroplating, whereby an Ni coating film and an Sn coating film were formed sequentially on the surface of each of the first to fourth external electrodes. In this manner, common mode choke coil samples Nos. 1′, 203′ and 209′ were produced.

With respect to sample No. 209′, an electrically conductive paste for external electrodes which contained Ag as the main component was applied to side surfaces of the component body, was then dried, and was then backed in an air atmosphere at 750° C., thereby forming first to fourth external electrodes. Thereafter, as in the case of samples Nos. 1′ and 203′, each of the first to fourth external electrodes was subjected to electroplating, whereby an Ni coating film and an Sn coating film were formed sequentially on the surface of each of the first to fourth external electrodes. In this manner, a common mode choke coil sample No. 209′ was produced.

Each of the samples thus produced had an outer size of 2.0 mm in length, 1.2 mm in width and 1.0 mm in thickness. In each of the samples, the interlayer distance between the first coil conductor and the second coil conductor was adjusted to 20 μm.

Subsequently, each of samples Nos. 1′, 203′ and 209′ was measured on an impedance value at a frequency of 100 MHz using an impedance analyzer (Agilent Technologies; E4991A).

In table 6, the ferrite compositions and measurement results for samples Nos. 1′, 203′ and 209′ are shown.

TABLE 6

| | | | | | | Impedance |
|---|---|---|---|---|---|---|
| Sample | Ferrite composition (mol %) | | | | | at 100 |
| No. | Fe₂O₃ | Mn₂O₃ | ZnO | CuO | NiO | MHz (Ω) |
| 1′ * | 49 | 0 | 30 | 1 | 20 | 300 |
| 203′ | 44 | 5 | 30 | 2 | 19 | 700-800 |
| 209′ * | 44 | 5 | 30 | 8 | 13 | 700-800 |

* out of the scope of the disclosure (claim 1)

As clearly known from Table 6, sample No. 1′ had an impedance value of as low as 300Ω. It is considered that this is because the specific resistance log ρ of sample No. 1 was as low as 2.8 and therefore the impedance value of this sample was decreased.

On the other hand, sample No. 203′ has a high impedance value of 700 to 800Ω. This is because the specific resistance log ρ of sample No. 203 was as high as 8.2.

Sample No. 209′ was a sample prepared using Ag as the electrically conductive material and performing the firing in an air atmosphere. Therefore, the reduction of Fe₂O₃ did not occur in this sample and therefore this sample had a good impedance result, i.e., an impedance value of 700 to 800Ω at a measurement frequency of 100 MHz.

Subsequently, with respect to each of samples Nos. 203′ and 209′, 30 pieces of test samples were used, and a moisture load life test was performed on these test samples by applying a direct-current voltage of 5 V between the first coil conductor and the second coil conductor under the conditions of a temperature of 70° C. and a humidity of 95% RH. Insulation resistance values of each of the test samples were measured at the time points of before the start of the test and 10 hours, 100 hours, 500 hours and 1,000 hours elapsed after the start of the test using an electrometer (Advantest Co.; R8340A), and an average of the resultant measurement values was determined.

In Table 7, the measurement results are shown.

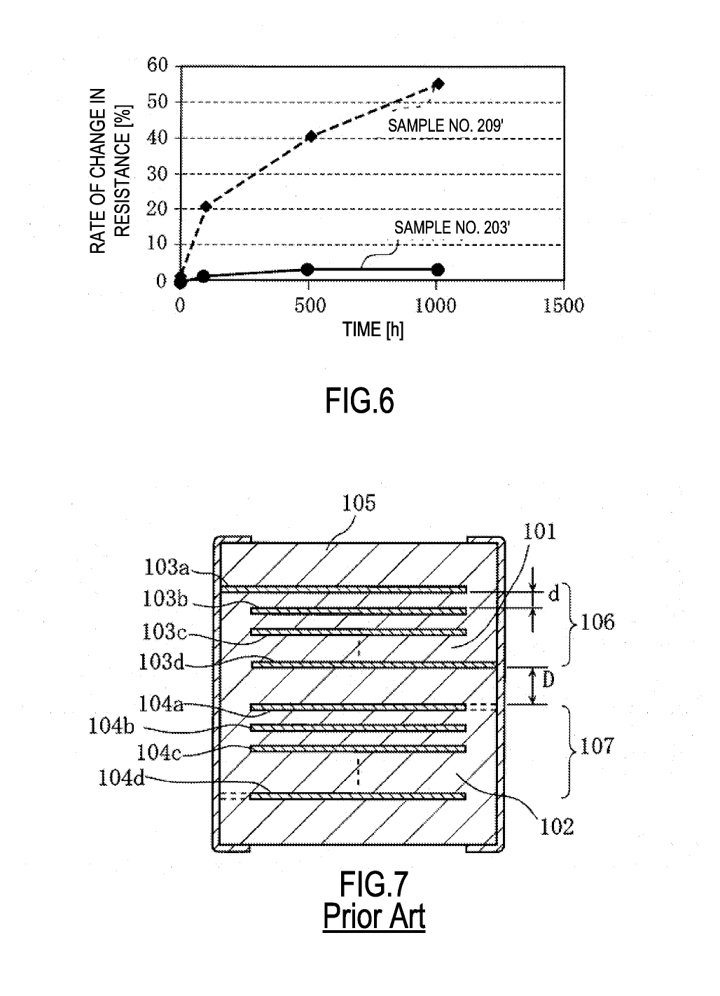

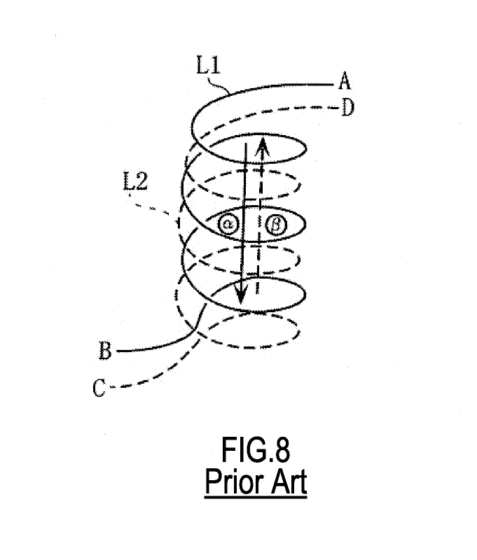

FIG. 5 illustrates the time course of the change in insulation resistance logIR, and FIG. 6 illustrates the time course of the rate of change in resistance. In FIGS. 5 and 6, a solid line represents the results of sample No. 203′ which is a sample of the present disclosure and a dashed line represents the results of sample No. 209′ which is out of the scope of the present disclosure. The abscissa axis in each of FIGS. 5 and 6 represents “time (h),” the ordinate axis in FIG. 5 represents “insulation resistance logIR (R: MΩ),” and the ordinate axis in FIG. 6 represents the rate of change in resistance (%).

TABLE 7

| | Sample No. | | | |
|---|---|---|---|---|
| | 203' | | 209'* | |
| | Insulation | Rate of | Insulation | Rate of |
| | resistance | decrease in | resistance | decrease in |
| Test time | logIR | resistance | logIR | resistance |
| (h) | (R:MΩ) | (%) | (R:MΩ) | (%) |
| 0 | 6.3 | — | 9.1 | — |
| 10 | 6.3 | 0 | 8.9 | 2.2 |
| 100 | 6.2 | 1.6 | 7.2 | 20.9 |
| 500 | 6.1 | 3.2 | 5.4 | 40.7 |
| 1000 | 6.1 | 3.2 | 4.1 | 54.9 |

*out of the scope of the disclosure (claim 1)

In Sample No. 209′, because Ag was used as the first and second coil conductors, migration occurred, the insulation resistance logIR was remarkably decreased with the elapse of time, the rate of change in resistance was increased to 54.9% 1,000 hours after the start of the test.

To the contrary, in sample No. 203′, because Cu was used as the first and second coil conductors, migration did not occur, the insulation resistance logIR was nearly unchanged with elapse of time, and the rate of change in resistance was 3.2% 1,000 hours after the start of the test (which is a good result). Thus, it was found that an alternately-wound common mode choke coil having a high coupling coefficient and high reliability was produced.

By using an electrically conductive material containing Cu as the main component, it becomes possible to provide a ceramic electronic component, e.g., an alternately-wound common mode choke coil, which has good insulation performance and good electric properties and rarely undergoes the occurrence of migration even when the ceramic electronic component is produced by firing a magnetic material together with the electrically conductive material.

In an embodiment of a ferrite ceramic composition in accordance with the present disclosure, the molar content of Cu is 0 to 5 mol % in terms of CuO content and, when the molar content (x (mol %)) of Fe in terms of Fe₂O₃ content and the molar content (y (mol %)) of Mn in terms of Mn₂O₃ content are expressed by a coordinate point (x,y), the coordinate point (x,y) is located within a specific area bounded by the above-mentioned coordinate points A to H. Therefore, when the ferrite ceramic composition is fired simultaneously with a Cu-based material, the occurrence of the oxidation of Cu or the reduction of Fe₂O₃ can be prevented, and therefore desired insulation performance can be secured without undergoing the decrease in specific resistance ρ.

Specifically, such good insulation performance that the specific resistance ρ is 10⁷ Ω·cm or more can be achieved. Consequently, it becomes possible to produce a desired ceramic electronic component having good electric properties including an impedance property.

Because the molar content of Zn is specified to 33 mol % or less in terms of ZnO content, a sufficient Curie point can be secured, and it becomes possible to produce a ceramic electronic component which can be operated under conditions including a high operation temperature.

Further, because the molar content of Zn is also specified to 6 mol % or more in terms of ZnO content, good magnetic permeability can be secured.

An embodiment of a ceramic electronic component according to the present disclosure includes a magnetic body part, a first coil conductor, and a second coil conductor which has substantially the same shape as that of the first coil conductor and of which the starting end and the terminal end are arranged with a predetermined distance apart from the first coil conductor, wherein the first coil conductor and the second coil conductor are embedded in the magnetic body part, and wherein each of the first coil conductor and the second coil conductor comprises an electrically conductive material containing Cu as the main component and the magnetic body part comprises the above-mentioned ferrite ceramic composition. Therefore, it becomes possible to produce a ceramic electronic component which can have desired good electric properties and magnetic properties and rarely undergoes migration, and can also have high reliability when the magnetic body part is fired simultaneously with the Cu-based material.

That is, because each of the first and second coil conductors is composed of an electrically conductive material containing Cu as the main component, even if the facing area between the first coil conductor and the second coil conductor is increased, the occurrence of migration can be avoided unlike the case in which an Ag-based material is used. Therefore, it becomes possible to produce an alternately-wound common mode choke which can exhibit good insulation resistance even when being allowed to be left for a long period under highly humid environments and has high reliability, as the ceramic electronic component.

Further, because the firing is performed in an atmosphere having an oxygen partial pressure equal to or lower than the equilibrium oxygen partial pressure for Cu—Cu₂O, when a magnetic body part is fired simultaneously with first and second coil conductors both comprising an electrically conductive material containing Cu as the main component, the sintering can be achieved without undergoing the oxidation of Cu and therefore it becomes possible to produce a common mode choke coil having good moisture resistance and high reliability.

An embodiment of a process for producing a ceramic electronic component according to the present disclosure includes a calcination step of precisely weighing an Fe compound, an Mn compound, a Cu compound, a Zn compound and an Ni compound in such a manner that the molar content of Cu becomes 0 to 5 mol % in terms of CuO content and, when the molar content (x (mol %)) of Fe in terms of Fe₂O₃ content and the molar content (y (mol %)) of Mn in terms of Mn₂O₂ content are expressed by a coordinate point (x,y), the coordinate point (x,y) is located within a predetermined area, mixing the weighed components together, and calcining the mixture, thereby producing a calcined powder; a ceramic thin layer body production step of producing ceramic thin layer bodies from the calcined powder; a first coil pattern formation step of forming a first coil pattern containing Cu as the main component on one of the ceramic thin layer bodies; a second coil pattern formation step of forming a second coil pattern containing Cu as the main component on another one of the ceramic thin layer bodies; a laminate formation step of a alternately laminating a predetermined number of the ceramic thin layer bodies each having the first coil pattern formed thereon and the predetermined number of the ceramic thin layer bodies each having the second coil pattern formed thereon, thereby forming a laminate having the first coil conductors and the second coil conductors embedded therein; and a firing step of firing the laminate in a firing atmosphere having an oxygen partial pressure equal to or lower than the equilibrium oxygen partial pressure for Cu—Cu₂O. Therefore, even when the ceramic thin layer body is fired simultaneously with the first and second coil conductors each containing Cu as the main component in a firing atmosphere having an oxygen partial pressure equal to or lower than the equilibrium oxygen partial pressure for Cu—Cu₂O, Fe is not reduced, and it becomes possible to produce a ceramic electronic component having good insulation performance and high reliability.

Further, because a via conductor for the second coil conductor, which is electrically isolated from the first coil pattern, is formed on the surface of each of the first-coil-pattern-formed ceramic thin layer bodies and a via conductor for the first coil conductor, which is electrically isolated from the second coil pattern, is formed on the surface of each of the second-coil-pattern-formed ceramic thin layer bodies, even if the facing area between the first coil conductor and the second coil conductor is large, it becomes possible to produce an alternately-wound common mode choke coil in which the occurrence of migration can be avoided.

What is claimed is:

1. A ferrite ceramic composition comprising at least Fe, Mn, Ni and Zn,
wherein the ferrite ceramic composition contains a molar content of Cu is 0 to 5 mol % in terms of CuO content and, when the molar content (x (mol %)) of Fe in the ferrite ceramic composition in terms of Fe₂O₃ content and the molar content (y (mol %)) of Mn in the ferrite ceramic composition in terms of Mn₂O₃ content are expressed by a coordinate point (x,y), the coordinate point (x,y) is located in an area bounded by coordinate points A (25,1), B (47,1), C (47,7.5), D (45,7.5), E (45,10), F (35,10), G (35,7.5) and H (25,7.5).

2. The ferrite ceramic composition according to claim 1, wherein the molar content of Zn is 33 mol % or less in terms of ZnO content.

3. The ferrite ceramic composition according to claim 1, wherein the molar content of Zn is 6 mol % or more in terms of ZnO content.

4. The ferrite ceramic composition according to claim 2, wherein the molar content of Zn is 6 mol % or more in terms of ZnO content.

5. A ceramic electronic component comprising:
a magnetic body part;
a first coil conductor; and
a second coil conductor which has substantially the same shape as that of the first coil conductor and of which the starting end and the terminal end are arranged with a predetermined distance apart from the first coil conductor, wherein
the first coil conductor and the second coil conductor are embedded in the magnetic body part,
each of the first coil conductor and the second coil conductor comprises an electrically conductive material containing Cu as the main component, and
the magnetic body part comprises the ferrite ceramic composition claimed in claim 1.

6. The ceramic electronic component according to claim 5, wherein the first and second coil conductors and the magnetic body part are fired simultaneously.

7. A ceramic electronic component comprising:
a magnetic body part;
a first coil conductor; and
a second coil conductor which has substantially the same shape as that of the first coil conductor and of which the starting end and the terminal end are arranged with a predetermined distance apart from the first coil conductor, wherein
the first coil conductor and the second coil conductor are embedded in the magnetic body part,
each of the first coil conductor and the second coil conductor comprises an electrically conductive material containing Cu as the main component, and
the magnetic body part comprises the ferrite ceramic composition claimed in claim 2.

8. The ceramic electronic component according to claim 7, wherein the first and second coil conductors and the magnetic body part are fired simultaneously.

9. A ceramic electronic component comprising:
a magnetic body part;
a first coil conductor; and
a second coil conductor which has substantially the same shape as that of the first coil conductor and of which the starting end and the terminal end are arranged with a predetermined distance apart from the first coil conductor, wherein
the first coil conductor and the second coil conductor are embedded in the magnetic body part,
each of the first coil conductor and the second coil conductor comprises an electrically conductive material containing Cu as the main component, and
the magnetic body part comprises the ferrite ceramic composition claimed in claim 3.

10. The ceramic electronic component according to claim 9, wherein the first and second coil conductors and the magnetic body part are fired simultaneously.

11. A ceramic electronic component comprising:
a magnetic body part;
a first coil conductor; and
a second coil conductor which has substantially the same shape as that of the first coil conductor and of which the starting end and the terminal end are arranged with a predetermined distance apart from the first coil conductor, wherein
the first coil conductor and the second coil conductor are embedded in the magnetic body part,
each of the first coil conductor and the second coil conductor comprises an electrically conductive material containing Cu as the main component, and
the magnetic body part comprises the ferrite ceramic composition claimed in claim 4.

12. The ceramic electronic component according to claim 11, wherein the first and second coil conductors and the magnetic body part are fired simultaneously.

13. The ceramic electronic component according to claim 5, wherein the firing is performed in an atmosphere having an oxygen partial pressure equal to or lower than the equilibrium oxygen partial pressure for Cu—Cu₂O.

14. The ceramic electronic component according to claim 6, wherein the firing is performed in an atmosphere having an oxygen partial pressure equal to or lower than the equilibrium oxygen partial pressure for Cu—Cu₂O.

15. A process for producing a ceramic electronic component, comprising:
a calcination step of precisely weighing an Fe compound, an Mn compound, a Cu compound, a Zn compound and an Ni compound in such a manner that the molar content of Cu becomes 0 to 5 mol % in terms of CuO content and, when the molar content (x (mol %)) of Fe in terms of Fe₂O₃ content and the molar content (y (mol %)) of Mn in terms of Mn₂O₂ content are expressed by a coordinate point (x,y), the coordinate point (x,y) is located within an area bounded by coordinate points A (25,1), B (47,1), C (47,7.5), D (45,7.5), E (45,10), F (35,10), G (35,7.5) and H (25,7.5), mixing the weighed components together, and calcining the mixture, thereby producing a calcined powder;
a ceramic thin layer body production step of producing ceramic thin layer bodies from the calcined powder;
a first coil pattern formation step of forming a first coil pattern containing Cu as the main component on one of the ceramic thin layer bodies;
a second coil pattern formation step of forming a second coil pattern containing Cu as the main component on another one of the ceramic thin layer bodies;
a laminate formation step of alternately laminating a predetermined number of the ceramic thin layer bodies each having the first coil pattern formed thereon and the predetermined number of the ceramic thin layer bodies each having the second coil pattern formed thereon, thereby forming a laminate having the first coil conductors and the second coil conductors embedded therein; and
a firing step of firing the laminate in a firing atmosphere having an oxygen partial pressure equal to or lower than the equilibrium oxygen partial pressure for Cu—Cu₂O.

16. The process for producing a ceramic electronic component according to claim 15, wherein
a via conductor for the second coil conductor, which is electrically isolated from the first coil pattern, is formed on the surface of each of the first-coil-pattern-formed ceramic thin layer bodies, and
a via conductor for the first coil conductor, which is electrically isolated from the second coil pattern, is formed on the surface of each of the second-coil-pattern-formed ceramic thin layer bodies.
